(19) United States
(12) Patent Application Publication
(10) Pub. No.: US 2024/0122193 A1
(43) Pub. Date: Apr. 18, 2024

(54) MILK-BASED EXPANDED FOOD PREPARATION, METHOD FOR OBTAINING SAME, AND USES THEREOF

(71) Applicant: COMPAGNIE LAITIERE EUROPEENNE, Condé-sur-Vire (FR)

(72) Inventors: Jean-Baptiste THOMAZO, Rennes (FR); Audrey KERVINIO, Liffre (FR); Valérie GAMERRE, Mesanger (FR); Lisa PICHON-DUCROCQ, Tremblay (FR)

(21) Appl. No.: 18/286,659

(22) PCT Filed: Apr. 15, 2022
(86) PCT No.: PCT/EP2022/060157

§ 371 Date: Oct. 12, 2023

(30) Foreign Application Priority Data
Apr. 16, 2021 (FR) FR2103965

(51) Int. Cl. A23C 9/18; A23C 9/152; A23P 30/34

(52) U.S. Cl. CPC A23C 9/18; A23C 9/1522; A23P 30/34

(57) ABSTRACT

The present invention relates to a new dry, expanded milk-based snack food product; it also relates to a method for the preparation thereof and to uses thereof.

This invention relates to a new dry food product of the expanded milk snack type; it also relates to its preparation method and uses thereof.

In particular, the Applicant has set itself the objective of manufacturing dairy snacks, also referred to as puffed milk balls, composed mainly, if not exclusively, of skimmed milk powder; this ingredient is of marked nutritional interest in that it comprises all the nutrients and the proteins of the milk and is particularly rich in minerals (calcium).

However, this objective comes up against technical difficulties resulting from the high lactose content of skimmed milk powder; lactose represents a technological brake on the development of snack-type food products, particularly when they are prepared by extrusion, because of the Maillard reactions it produces with the proteins present in the skimmed milk powder (Navale et al. 2015, Journal of Ready to Eat Food, July-September 2015, Vol 2, Issue 3, pp. 66-80) and which degrade the taste and the appearance of the finished products.

Unexpectedly, the Applicant has succeeded in preparing an expanded product with good organoleptic properties, characterised by a high skimmed milk powder content, it contains at least 85% by weight, and a high lactose content, present at least 45% by weight, and a low or non-existent starch product content.

The food product thus obtained has advantageous nutritional properties in that it is rich in protein and calcium and has no added sugars.

There are currently three types of snack-type dry food products:
products with a predominantly starchy composition which may contain other ingredients, in particular protein ingredients, or even dairy ingredients, such as those described in EP1480528 or in EP1300083; however, these products have a much lower dairy ingredient content than those of the present invention;
dairy products in which the dairy ingredient is represented solely by a purified milk protein, in particular casein which has an expansive behaviour, such as those described in U.S. Pat. No. 9,723,859 and U52017/311624; these products are generally low in lactose;
dairy products containing the necessary and sufficient quantity of starch to be able to expand (generally at a content of between 15 and 30% by weight); in this case, the milk is represented solely by whey proteins, which are not expansive, see in particular WO2006/130025.

The present invention relates to an expanded dry food product comprising (the contents are expressed in % by weight based on the total weight of the ingredients used to prepare the product):
between 85 and 100%, preferably between 90 and 98%, even more preferably about 97.5%, of skimmed milk powder;
optionally, up to 15%, preferably between 2 and 10%, even more preferably about 2.5%, of an expansion-promoting ingredient;
optionally, up to 15%, preferably up to 12%, even more preferably up to 10% of fat;
optionally, up to 5% of markers and/or ingredients of nutritional interest.

The skimmed milk powder, fermented or not, is obtained from whole milk which has been skimmed, fermented if necessary, and then dried; it has the following characteristics:

TABLE 1

| | Range of contents (by weight) |
|---|---|
| Fat | 0.5-1.5% |
| Carbohydrates (in the | 45-55% |
| absence of fermentation) | |
| Proteins | 32.5-38% |
| Moisture | 2-5% |

The fermented skimmed milk is prepared using fermentation techniques well known to those person skilled in the art.

The skimmed milk powder can also be a mixture of skimmed milk powder and fermented skimmed milk powder.

The expansion-promoting ingredients can be selected from starch compounds and minerals.

Starch compounds are cereal, legume and pseudo-cereal flours, as well as purified starches obtained after separation of the protein fraction present in the flours. The starches are themselves composed of two types of molecules in varying proportions (amylose and amylopectin) organised into complex particles referred to as pseudo-crystalline, i.e. partially crystalline and partially amorphous. In its native state, the starch is present in the form of granules in the micron to ten micron range integrated into tissues (endosperm of the cereals, for example) present in many botanical species, where it acts as an energy reserve. The most common sources of starch compounds are the cereal flours, particularly wheat flour. Other alternatives are also used, such as: other cereal flours, refined or wholemeal: rice, maize, oats, barley, spelt, small spelt, triticale, etc.; pseudo-cereal flours (quinoa, amaranth and buckwheat) or leguminous (peas, lentils, beans, chickpeas). The starches and flours can be subjected to physical, enzymatic and/or chemical treatments that modify their technological properties, in particular solubility and texturing power.

Preferably, the starchy compound is rice flour.

Minerals are defined as mineral or organic salts of calcium, magnesium, phosphorus, sodium or potassium or mixtures thereof; preferably, the minerals are selected from the citrates, the chlorides, the phosphates, the sodium, calcium and potassium carbonates.

Fat is taken to mean a fat of animal origin, preferably dairy, or vegetable, or a mixture thereof; if a vegetable fat is used, it will preferably be oils such as rapeseed, sunflower, oleic sunflower, olive, etc. or concrete to semi-concrete fats such as cocoa butter, shea butter, palm, palm kernel, copra, etc. the dairy fat can be butter, cream or anhydrous dairy fat. Preferably, it is a milk fat.

According to a particular embodiment, the fat may be provided by a milk fat powder selected from partially skimmed milk powder (fat content of between 1.5% and 26%), whole milk powder (fat content of at least 26%), cream powder (fat content of at least 42%) and/or butter powder (fat content of at least 56%); according to this embodiment, the milk fat powder can be partially substituted for the skimmed milk powder; consequently, a quantity of skimmed milk powder of less than 85% by weight can be used to take account of the contribution of non-fat milk matter represented by these powders.

According to this embodiment and by way of illustration only, the expanded dry food product can then be prepared with:
80% of skimmed milk powder,
15% of whole milk powder, representing an equivalent contribution of approximately 11.1% of skimmed milk powder and 3.9% of milk fat, and
5% of an ingredient that promotes the expansion.

Markers and/or ingredients of nutritional interest mean:
food ingredients intended to improve the organoleptic qualities of the product according to the invention (texture, taste, colour); these may be flavourings, spices, aromatic herbs, pieces of dried fruit or vegetables, processed food products such as chocolate, cheese, colourings, etc.; the markers may be added to the finished product, for example by sprinkling or coating; they may also be introduced among the starting ingredients and thus be included in the product according to the invention; and/or
vitamins and minerals.

The expanded dry food product according to the invention can be presented in various three-dimensional shapes, for example in the form of a ball, star, bean or annulus, with a characteristic dimension of between 2 and 20 mm; it is dry, honeycombed, crispy and light; it has a density of between 100 and 350 g/l and a moisture level of between 3 and 10%.

The density of the product according to the invention can be measured as follows:
a) taring a container with a volume of 1 L;
b) filling this container with the product and level it with the back of the blade of a straight knife;
c) weighing the mass of product contained in this jar;
d) given that the volume of product weighed is 1 L, reading the density given directly by the value on the balance.

By virtue of its ingredients, the product according to the invention allows to provide a nutritional contribution equivalent to liquid milk: 25 g of crisps are equivalent to a 250 mL glass of milk. In this way, the expanded dry food product according to the invention is useful for bone health and allows milk to be consumed in a new form, as a substitute for milk in beverage form. It represents a new range of long-life milk.

By way of illustration, the nutritional composition of the expanded dry food product according to the invention obtained with unfermented milk is as follows (contents expressed by weight relative to the total weight of the final product):
between 25 and 38% of milk proteins;
between 45 and 55% of lactose;
between 0 and 9% of starch;
between 0.5 and 16% of fat;
between 1 and 2.6% of calcium.

According to a particular embodiment, the expanded dry food product consists of (the contents are expressed in % by weight with respect to the total weight of the ingredients used to prepare the product):
between 85 and 100%, preferably between 90 and 98%, even more preferably about 97.5%, of skimmed milk powder;
optionally, up to 15%, preferably between 2 and 10%, even more preferably about 2.5%, of an expansion-promoting ingredient;
optionally, up to 15%, preferably up to 12%, even more preferably up to 10% of fat;
optionally, up to 5% of markers and/or ingredients of nutritional interest.

In a particular embodiment, the expanded dry food product is composed solely of ingredients of dairy origin and the expansion-promoting ingredient is a mineral.

Even more preferably, the expanded dry food product is composed solely of ingredients of lean dairy origin, i.e. it implements a skimmed milk powder composed of no more than 1.5% of fat, no fat is added during the preparation of the product and the expansion-promoting ingredient is a mineral.

The present invention also relates to a method for preparing the expanded dry food product according to the invention; this method is implemented with a co-rotating twin-screw extruder and comprises the steps of:
a) introducing the dry raw materials making up the expanded dry food product according to the invention at the inlet of the extruder;
b) adding the liquid ingredients into the extruder; the quantity of water added to the raw materials represents between 10 and 20% by weight of said mixture of raw materials;
c) cooking-extruding the ingredients prepared in steps (a) and (b);
   the temperature of the sheats of the extruder is adapted according to the apparatus used; it may, for example, be between 70 and 90° C.; the feed rate into the extruder is determined by the person skilled in the art, again according to the apparatus used; by way of illustration, it may be of the order of 75 kg/h for a pilot apparatus and of the order of 300 kg/h for an industrial apparatus;
   the size of the die is chosen according to the diameter of the strand required; it can be between 1 and 10 mm, preferably around 3 mm;
d) hot cutting the cylinder obtained in step (c) to form snacks;
   this step can be carried out using a grinder/granulator knife; and
e) drying the snacks obtained in step (d);
   this step can be carried out in an oven or in a fluidised bed (for example, heated in air at around 110° C. for 2 to 3 minutes);
f) optionally, coating the snacks obtained in step (e);
g) optionally, grinding the snacks obtained in step (e).

Preferably, the screw profile of the extruder is chosen so as to limit the shearing of the ingredients it contains in order to avoid an overheating of said ingredients and their browning by the Maillard reaction. In this context, it is preferable that the temperature of the product leaving the extruder (after step (c)) does not exceed 122° C., preferably 112° C., and is generally between 102° C. and 122° C.

The expanded dry food product according to the invention has many applications.

It can be eaten as is in the form of snacks, possibly flavoured, mixed with breakfast cereals or added to culinary preparations such as salads, soups, yoghurt and ice creams. It can also be coated with a covering element (chocolate, fat, sugar, caramel, etc.).

The expanded dry food product according to the invention can also be used as an ingredient in the preparation of processed products such as cereal bars and fodder bars, in which it adds crispy. A binder (fat, sugar, honey, egg, filler, etc.) may be added to prepare these processed products.

The invention thus relates to a processed product comprising the expanded dry food product according to the invention.

The expanded dry food product according to the invention can also be coarsely ground, for example using an apparatus such as an electric cheese grater or breadcrumb mill, to prepare a breadcrumb-type product, the breadcrumb-type product composed of the expanded dry food product according to the invention in ground form is also an object of the invention; it can then be used on its own or as an ingredient in the manufacture of pie bases, biscuits, filling bars or cereal bars, or for breading meat, fish or cheese, or for decorating ice creams or chocolate.

### EXAMPLE 1: PREPARATION OF THE EXPANDED SNACK ACCORDING TO THE INVENTION

1. Pre-weighing of the powders with the following composition:
   Skimmed milk powder 95%
   Rice flour 5%
2. Carrying out the test using an extruder with the following parameters:
   Twin-screw model
   Die: 2×7 mm diameter
   Sheats temperature setpoint: 70° C.
   Rotational speed of the screws: 300 rpm
   Powder feed rate: 75 kg/h

The resulting product is a strand about 12 mm in diameter, with a density of close to 250 g/L, a golden appearance, with a pleasant crispness and a dairy flavour. For example, the product obtained can then be dried and ground to obtain fine breadcrumbs for making biscuits or pie bases.

### EXAMPLE 2: PREPARATION OF AN EXPANDED SNACK ACCORDING TO THE INVENTION

We proceed in the same way as in example 1, with the following composition:
Skimmed milk powder 97.5%
Dairy mineral concentrate 2.5%

The product obtained is similar in diameter, density and crispness to that described in Example 1, with a typical dairy and pleasantly sweet taste.

### EXAMPLE 3: PREPARATION OF AN EXPANDED SNACK ACCORDING TO THE INVENTION

We proceed in the same way as in example 1, with the following composition:
Fermented skimmed milk powder 52.5%
Skimmed milk powder 47%
Monopotassium phosphate 0.5%

The product obtained is similar in diameter, density and crispness to that described in Example 1, with a typical taste of fermented milk.

### EXAMPLE 4: PREPARATION OF AN EXPANDED SNACK ACCORDING TO THE INVENTION

We proceed in the same way as in example 1, with the following composition:
Skimmed milk powder 85%
Anhydrous milk fat 14.5%
Monopotassium phosphate 0.5%

The resulting product is similar in diameter, density and crispness to that described in Example 1, with a more intense dairy taste and a slightly whiter colour.

### EXAMPLE 5: PREPARATION OF AN EXPANDED SNACK ACCORDING TO THE INVENTION

We proceed in the same way as in example 1, with the following composition:
Whole milk powder 52.5%
Skimmed milk powder 45%
Dairy mineral concentrate 2.5%

The resulting product is similar in diameter, density and crispness to that described in Example 1, with a more intense dairy taste and a slightly whiter colour.

1. An expanded dry food product comprising:
between 85 and 100% of a skimmed milk powder;
optionally, up to 15% of an ingredient that promotes expansion;
optionally, up to 15% of fat; and
optionally, up to 5% of markers and/or ingredients of nutritional interest.

2. The expanded dry food product according to claim 1, characterized in that it comprises between 90 and 98% of the skimmed milk powder.

3. The expanded dry food product according to claim 1, characterized in that it comprises only ingredients of dairy origin and the ingredient that promotes expansion is a mineral.

4. The expanded dry food product according to claim 1, characterized in that it consists of the skimmed milk powder and the ingredient that promotes expansion is a mineral.

5. The expanded dry food product according to claim 1, characterized in that the ingredient that promotes expansion is a mineral chosen from citrates, chlorides, phosphates, sodium, calcium and potassium carbonates.

6. The expanded dry food product according to claim 1, characterized in that it is in a form of a three-dimensional shape with a characteristic dimension of between 2 and 20 mm and is dry, honeycombed and crispy.

7. The expanded dry food product according to claim 1, characterized in that it has a density of between 100 and 350 g/l.

8. The expanded dry food product according to claim 1, characterized in that it has a moisture level of between 3 and 10%.

9. The expanded dry food product according to claim 1, characterized in that it contains lactose at a content of between 45 and 55% by weight relative to a total weight of said food product.

10. A method for preparing the expanded dry food product according to claim 1, implemented with a co-rotating twin-screw extruder and the method comprising:
a) feeding dry raw materials making up the expanded dry food product at an inlet of the extruder;
b) injecting liquid ingredients into the extruder; a quantity of water added to the raw materials is between 10 and 20% by weight of said raw materials;
c) cooking-extruding the ingredients prepared in steps (a) and (b) to provide a cylinder;
d) hot cutting the cylinder obtained in step (c) to form snacks;
e) drying the snacks obtained in step (d);
f) optionally, coating the snacks obtained in step (e); and
g) optionally, grinding the snacks obtained in step (e).

11. (canceled)

12. A processed product comprising the expanded dry food product according to claim 1.

13. A breadcrumb-type product composed of the expanded dry food product according to according to claim 1, in ground form.
